(19) United States
(12) Patent Application Publication
(10) Pub. No.: US 2014/0284152 A1
(43) Pub. Date: Sep. 25, 2014

(54) DISC BRAKE, IN PARTICULAR FOR UTILITY VEHICLES, PRESSURE PLATE OF A DISC BRAKE OF SAID TYPE, AND BRAKE PAD OF A DISC BRAKE OF SAID TYPE

(71) Applicant: WABCO Radremsen GmbH, Mannheim (DE)

(72) Inventor: Denny Moeller, Gossel (DE)

(21) Appl. No.: 14/356,571

(22) PCT Filed: Nov. 8, 2012
(86) PCT No.: PCT/EP2012/004650

§ 371 Date: May 6, 2014

(30) Foreign Application Priority Data
Nov. 11, 2011 (DE) 10 2011 118 314.4

(51) Int. Cl. F16D 65/095

(52) U.S. Cl. CPC F16D 65/095
USPC 188/73.31; 188/250 B

(57) ABSTRACT

A brake disc, in particular for utility vehicles, having a brake pad, having a brake-application device for pressing the brake pad against a brake disc, and having a pressure plate via which the brake-application device presses the brake pad against the brake disc during braking. A projection is provided on the pressure plate and a recess is provided on the brake pad. In the assembled state, the recess receives the projection and has the at least one first inner delimitation which constitutes a stop for the lateral outer delimitation of the projection in the circumferential direction.

### CROSS REFERENCE TO RELATED APPLICATION

The present application is a 35 U.S.C. §371 national phase entry application of, and claims priority to, International Patent Application No. PCT/EP2012/004650, filed Nov. 8, 2012, which claims priority to German Patent Application No. DE 102011118314.4, filed Nov. 11, 2011, the disclosures of which are hereby incorporated by reference in their entirety for all purposes.

### BACKGROUND

The invention relates to a disc brake, in particular for utility vehicles, having a brake pad, having a brake-application device for pressing the brake pad against a brake disc, and having a pressure plate via which the brake-application device presses the brake pad against the brake disc during braking.

Disc brakes of the initially described type are known.

Such brakes, for example, can be actuated pneumatically and/or electromechanically. By means of a relatively small target area of the brake-application device arranged in the brake caliper using at least one pressure spindle device, a large force component is introduced perpendicular to the brake disc plane on an extensive brake pad consisting of a pad carrier plate (brake pad plate) and a friction lining which is attached to said pad carrier plate and contacts the brake disc during braking.

### BRIEF DESCRIPTION OF THE DRAWINGS

FIG. 1 shows a schematic top view of a disc brake according to one of the embodiments of the invention;

FIG. 2 shows the pressure plate of the brake according to FIG. 1 and its guide in the brake part;

FIG. 3 shows a cutaway view along the line III-III in FIG. 1;

FIG. 4 shows a schematic cutaway view through a brake pad, and a pressure plate of the brake according to FIG. 1;

FIG. 5 shows a magnified schematic depiction of the brake pad and the pressure plate of the brake according to FIG. 3 behind the brake pad;

FIG. 6 shows the same depiction as FIG. 5 but a different embodiment; and

FIG. 7 shows the same depiction as FIGS. 5 and 6 but from a third embodiment.

### DETAILED DESCRIPTION

For reasons of cost effectiveness (e.g., weight, material) and narrow space conditions (installation spaces), the brake pad plate is not designed to be excessively thick and flexurally rigid. Therefore, in brakes according to the invention, a pressure plate or pressure distribution plate is inserted between the brake-application device and the brake pad plate. Said pressure plate is designed with appropriate flexural rigidity to ensure that the brake pad is pressed against the brake disc as evenly and deformation-free as possible over its contact surface extending approximately over the surface of the brake pad plate.

The invention particularly relates to such brakes which have both brake pad and pressure plate as separate components and are radially installed in and removed from the brake by means of a brake caliper opening. This applies to re-equipping, in case of maintenance during brake inspection, and replacement of a pressure plate and/or brake pad. Preferably, the pressure plate is not wider than the brake pad.

The two components brake pad and pressure plate, for example, are guided laterally and/or radially inward on preferably extensive contact surfaces, and/or are supported by said surfaces, in slot guides on the side of the brake-application device in a stationary brake carrier and/or in the brake caliper. The delimitations for the brake pad on both sides can be formed by support horns.

Radially, the brake pad is frequently guided on contact surfaces which are located on an extension or a connecting yoke between the support horns.

The invention is particularly applicable for disc brakes in which the brake pads and the pressure plate are braced in the required position by means of hold-down springs and a hold down in order to prevent rattle sounds and as safeguard against falling out of the brake.

For disc brakes of a certain size, particularly for disc brakes in utility vehicles, it is necessary, depending on application, to use brake pads of different pad quality and/or different dimensions. This also applies to the pressure plate.

Due to these different embodiments, mistakes with regard to assignment and parts installation cannot be ruled out. For example, it is possible that in case of maintenance (pad replacement), brake pads are installed, e.g. with slightly deviating dimensions with regard to the present brake pad slots, or installation positions or installation sides are mixed up. Cases are also known in which maintenance intervals were disregarded and the brake pad was pulled into the space between the brake disc and the slot guide due to the remaining pad/brake disc falling below the permissible thickness.

The problem addressed by the invention is that of developing the disc brake of the initially described type such that the operating safety' and functional reliability as well as maintenance suitability can be improved with minor constructive effort, whilst taking cost effectiveness into account.

According to the invention, the stated problem is solved by a projection on the pressure plate and a recess on the brake pad which, in the assembled state, receives the projection and has at least one first inner delimitation which constitutes a stop for a lateral outer delimitation of the projection in the circumferential direction.

In other words, the brake pad has a recess/notch in which the projection of the pressure plate is immersed and the brake pad which is supported in circumferential direction thus circumferentially supports and guides the pressure plate by means of the projection. Simultaneously, this also results in an encoding which proceeds particularly from the pressure plate. Thus, the pressure plate is only compatible with the corresponding brake pad. Since the encoding involves the pressure plate and the brake pad, no additional work or special adjustments on the brake caliper and/or the brake carrier are required. This significantly contributes to cost effectiveness.

According to a particularly preferred embodiment of the invention, the depth of the recess corresponds at least to the thickness of a brake pad plate of the brake pad. If the brake pad is further shifted due to the remaining pad/brake disc falling below the permissible thickness, it therefore still encompasses the projection and, depending on position and direction of disc rotation, “hooks up” to said projection such that it cannot be pulled into the space between brake pad and slot guide.

According to a further preferred embodiment of the invention, the projection is positioned in the radially inward region of the pressure plate and/or the recess is positioned in the radially inward region of the brake pad.

Since, for example, the brake pad is directly inserted radially in case of a fitted pressure plate and the projection does not necessarily have to be encompassed by the recess on all sides, no axial movements of the brake pad with regard to the pressure plate are required in order to bring the two components into contact. This applies both to assembly and removal.

Furthermore, in this embodiment, only a negligible portion of the friction surface is lost due to the recess. Moreover, the projection and the recess are in an approximately “force-neutral” region. If, in contrast, the projection or the recess were approximately in the middle region of the pressure plate or the brake pad, it would be in the force transmission center where, for example, a pressure spindle transmits the braking force. This could result in material stress and/or material cracks. In addition, it would provide for the aforementioned disadvantageous form-fitting which complicates installation.

According to the invention, the projection is further preferably integral with the pressure plate. This reduces the number of parts and also provides for a particularly simple installation/removal.

According to a particularly preferred embodiment of the invention, a radial outer delimitation of the projection constitutes a stop for a second inner delimitation of the recess in radial direction.

In other words, in this embodiment, the brake pad is seated radially inward on the projection while the pressure plate is still supported/guided in circumferential direction by means of the brake pad. As a result, the guide properties can be improved because the contact surfaces, depending on application, can be optimized among themselves—in this case relative to the fixed part.

Finally, according to the invention, the pressure plate is provided particularly preferred as a separate component.

It must be expressly pointed out that the encoding according to the invention does not necessitate a recess in the form of an opening. Instead, the recess can also have the form of an indentation (blind hole). If the aforementioned radial support/guide is not desired, it does not have to be delimited on all sides by side walk. Instead, the side walls can also form a “U.”

In addition to the disc brake describe in detail above, the invention also provides for a pressure plate and a brake pad of such a disc brake.

In the following, the invention is described in further detail using preferred embodiments with reference to the attached drawing.

The disc brake depicted in the drawing according to an embodiment of the invention comprises a caliper 10 which is a sliding caliper, and a radial opening 12, a brake carrier 14, a brake pad 16 on the side of the rim, a brake pad 18 on the side of the brake-application device, a pressure plate 20, hold-down springs 22, 24, 26 for the brake pads 16 and 18 and the pressure plate 20, and a hold down yoke 28 acting as hold down for the hold-down springs 22, 24, and 26.

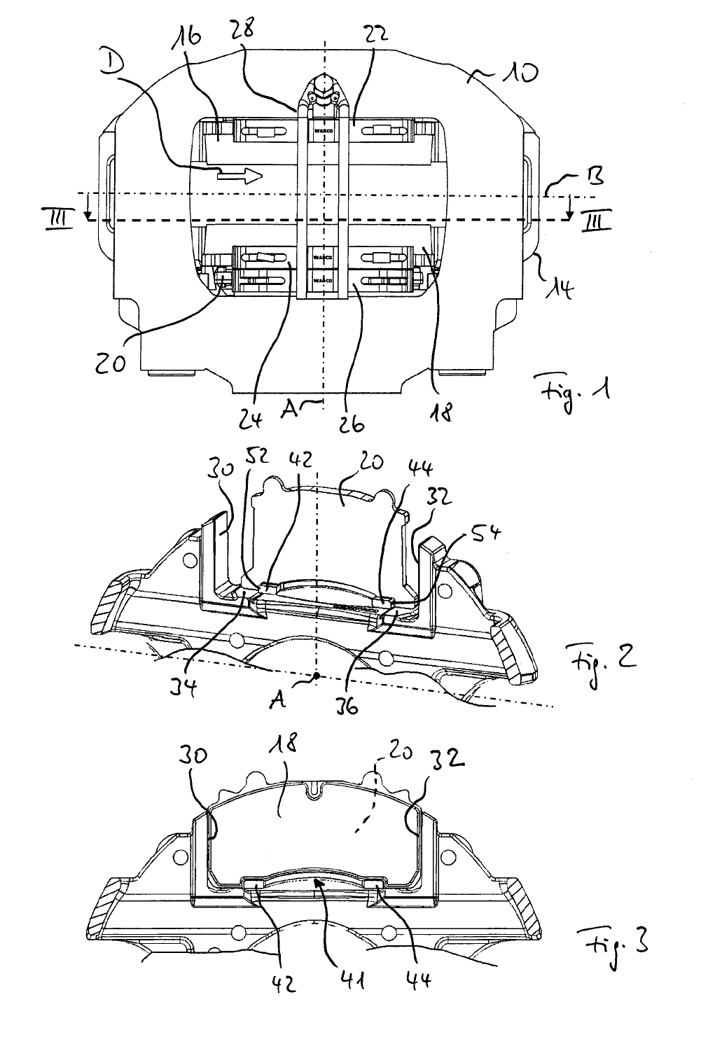

Inside the lower part of the brake caliper 10 in FIG. 1, a brake-application device for applying the brake is positioned which is not depicted. During braking, it presses against the pressure plate 20 which, in turn, presses the brake pad 18 against a brake disc not depicted in the drawing. The brake disc plane B is shown with a broken line. The occurring reaction force shifts the brake caliper 10 in FIG. 1 downward, causing the brake pad 16 to also be pressed against the brake disc. The brake-application device also comprises a pressure spindle device not depicted in the drawing, by means of which the brake can be adjusted for compensating wear. The preferred rotational direction of the brake disc during forward motion is indicated with an arrow D.

The brake pads 16, 18 and the pressure plate 20 are guided and/or supported in slot guides of the brake caliper 10 and/or the brake carrier 14. They can be installed/removed through the opening 12.

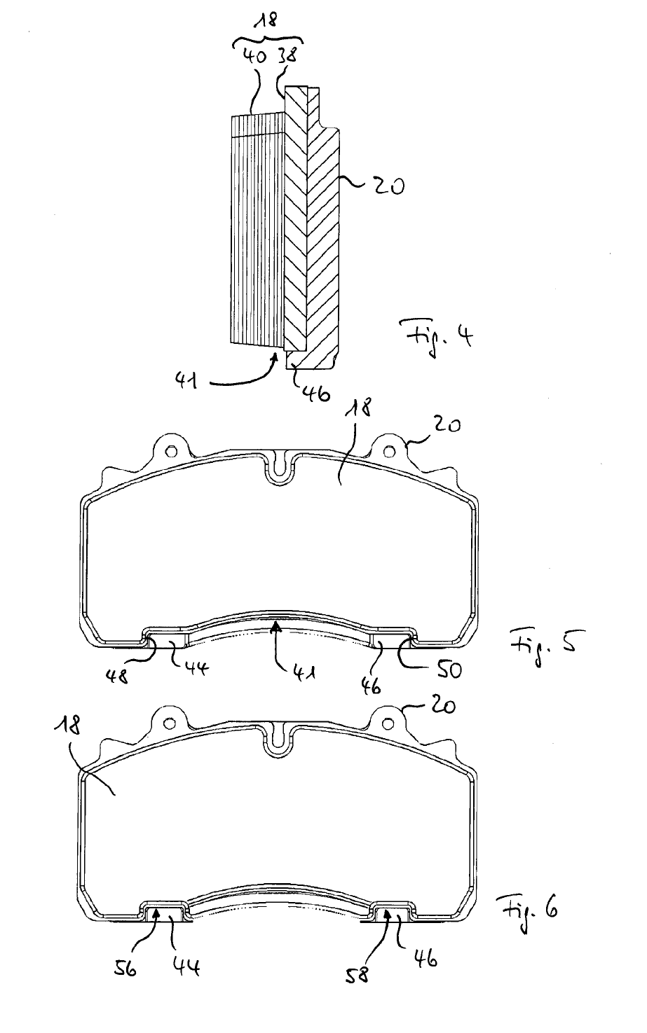

FIG. 3 shows the brake pad 18 on the side of the brake-application device with the pressure plate 20 (broken indicating line) behind it, both positioned within a substantially U-shaped slot guide. The brake pad 18 is wider than the pressure plate 20.

The slot guides include contact surfaces 30, 32 which act in circumferential direction, and supports 34, 36 which act in radial direction, each relative to the brake axis A. The pressure plate is radially supported by means of the supports 34, 26. The brake pad 20 is supported in circumferential direction, depending on the rotational direction, by means of the contact surfaces 30 or 32.

The brake pad 18 has a brake pad plate 38 and a friction lining 40.

As can be seen particularly from a combined view of FIGS. 3, 4, and 5, the brake pad 18 in the depicted embodiment, has a radially inward recess 41 for engaging the two projections 44 and 46 and the pressure plate 20. Lateral inner delimitations 48, 50 of the recess 41 constitute a stop for lateral outer delimitations 52 and 54 of the projections 42 and 44. Since the brake pad 18, depending on the rotational direction of the brake disc, either stops on contact surface 30 or contact surface 32 during braking, the pressure plate 20 is prevented by the projections 42, 44 from rotating with the brake disc in circumferential direction. It is thus held and guided in circumferential direction.

According to FIG. 4, the length of the projection 46 is slightly shorter than the depth of the recess 41. However, it is expressly noted that the invention also covers solutions with the length of the projection 46 being equal or slightly longer than the depth of the recess 41, i.e. the projection thus extending into the region of the friction lining 40. It must be ensured that the projection 46 can hold the brake pad 18 even if the friction lining 40 is greatly depleted.

The recess 41 encompasses the projections 44 and 46 only on three sides and not entirely. Instead, it is open in radially inward direction. This offers significant advantages during assembly/removal.

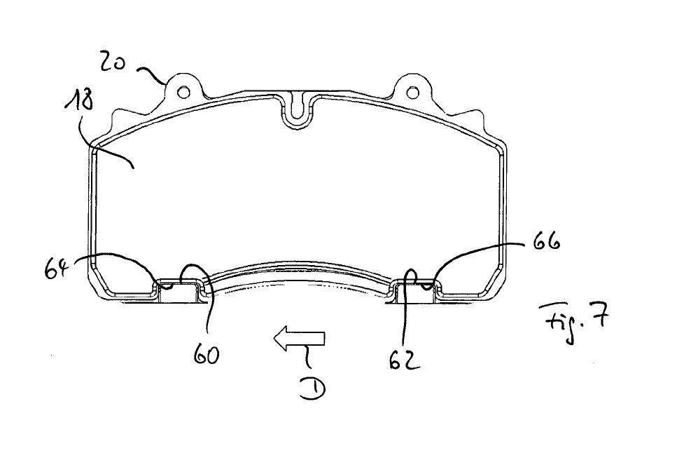

The embodiment according to FIG. 6 substantially corresponds to that of FIG. 5, and differs only in that, instead of the single recess 41 according to FIG. 6, two recesses 56, 58 are provided, one for each of the projections 44 and 46. This ensures an even better guide and support for the pressure plate in circumferential direction.

The embodiment according to FIG. 7 substantially corresponds to that of FIG. 6, and differs only in that the radial outer delimitations 60 and 62 of the projections 44 and 46 each for a stop for inner delimitations 64 and 66 of the recesses 56 and 58. As a result, the pressure plate 20, which is supported and guided by the supports 34 and 36, can act as radial support and guide of the bake pad 18. In this embodiment, the brake pad 18 supports and guides the pressure plate 20 in circumferential direction while the pressure plate 20 supports and guides the brake pad 18 in radial direction.

In the depicted embodiments, two projections and one or two recess are provided each. However, the invention is not limited to these embodiments. In fact, more recesses and more or fewer projection can be provided. The aforementioned encoding can be realized by means of varying the forms, the number and/or the positioning of the recesses and/or the projections. Thus, as seen looking in circumferential direction, different positions between brake pad and pressure plate are also possible.

The features of the invention disclosed in the above description, the claims, and the drawing can be essential both individually and in any type of combination for the realization of the invention in its various embodiments. Furthermore, the invention is not limited to the sliding caliper disc brake described in the embodiment but also applies to other caliper designs, such as fixed or floating caliper disc brakes.

1. A disc brake, in particular for utility vehicles, comprising:
a brake pad,
a brake-application device for pressing the brake pad against a brake disc, and
a pressure plate via which the brake-application device presses the brake pad against the brake disc during braking,
characterized by
a projection on the pressure plate and a recess on the brake pad which, in an assembled state, receives the projection and has at least one first inner delimitation which constitutes a stop for a lateral outer delimitation of the projection in a circumferential direction.

2. The disc brake according to claim 1, characterized in that a depth of the recess corresponds at least to a thickness of a brake pad plate of the brake pad.

3. The disc according to claim 1, characterized in that the projection is positioned in a radially inward region of the pressure plate, and the recess is positioned in a radially inward region of the brake pad.

4. The disc brake according to claim 1, characterized in that the projection is integral with the pressure plate.

5. The discs brake according to claim 1, characterized in that a radial outer delimitation of the projection constitutes a stop for a second inner delimitation of the recess in a radial direction.

6. The disc brake according to claim 1, characterized in that the pressure plate is a separate component.

7. A pressure plate of a disc brake according to claim 1.

8. A brake pad of a disc brake according to claim 1.
